(19) United States
(12) Patent Application Publication
(10) Pub. No.: US 2004/0096805 A1
(43) Pub. Date: May 20, 2004

(54) Prosthesis for tooth surface

(75) Inventors: Sueo Saito, Tokyo (JP); Tetsuro Sakuma, Tokyo (JP); Futoshi Fusejima, Tokyo (JP); Toshihiro Sekiguchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: GC Corporation, Tokyo (JP)

(21) Appl. No.: 10/632,811

(22) Filed: Aug. 4, 2003

(30) Foreign Application Priority Data
Aug. 6, 2002 (JP) 2002-229108

(51) Int. Cl. A61C 5/08

(52) U.S. Cl. 433/218

(57) ABSTRACT

A prosthesis for a tooth surface, which requires neither careful formation of an abutment tooth nor indirect production of the dental prosthesis outside the oral cavity, and can be fixed inside the oral cavity in a time, the prosthesis having a shape resembling a labial side surface of an anterior tooth, a buccal side surface and an approximal surface or an occlusal surface of a molar tooth, or a buccal surface or an approximal surface and an occlusal surface of a molar tooth, a back surface thereof being attached to a lingual side tooth formed by constructing with a lingual side tooth forming resin material on an abutment tooth, and comprising a polymer of a mixture of a polymerizable compound having an unsaturated double bond, a filler and a polymerization initiator. The prosthesis may be a veneering type having a thickness of 0.1 to 2 mm at a labial surface of an anterior tooth or a buccal side surface, an approximal surface or an occlusal surface of a molar tooth, and may have, on a back surface thereof, a protrusion having a hole or a slot for engaging a post implanted on a tooth root of a remaining tooth.

### BACKGROUND OF THE INVENTION

1. Field of the Invention

The present invention relates to a prosthesis for a tooth surface having such wear resistance and aesthetic property that are equivalent to those of the conventional hard resin, and being capable of forming a dental prosthesis in a short period of time by attaching to a lingual side tooth formed by build-up with a lingual side tooth forming resin material on an abutment tooth.

2. Description of Conventional Art

In the case where a tooth suffers deficiency or a part of a tooth is lost, such a remedy has been widely practiced that an abutment tooth, is formed at a therapeutic area of a patient, and a dental prosthesis resembling a tooth form, which is referred as a crown or a bridge, to be attached to the abutment tooth is produced outside an oral cavity, and then fixed to the abutment tooth. At this time, in the case where an aesthetic property equivalent to a natural tooth is required, such a dental prosthesis is used as an acrylic faced cast crown, a metal crown with porcelain facing, an acrylic facing cast bride, a metal bridge with porcelain facing and a full ceramic crown.

In the case where a dental prosthesis is fixed to a remaining tooth, and the remaining tooth has a substantially complete shape and can be used as an abutment tooth, a dentist necessarily machines the remaining tooth into a shape proximate to a circular conic form with a turbine before producing the dental prosthesis. Because a dental prosthesis is directly fixed to an abutment tooth, the operation for forming the abutment tooth must be carefully carried out under consideration of the shape and the structure of the dental prosthesis to be produced later and thus requires a long period of time. Furthermore, in the case where a dental prosthesis is fixed to a tooth, but only a tooth root of the remaining tooth remains, such an operation is necessary that a post formed with a metallic material or the like is implanted and fixed to a root canal, an abutment tooth built-up on a side of an occlusal surface of the tooth root by using a dental composite resin for core build-up, followed by carefully machining the abutment tooth in the similar manner as in the foregoing.

Subsequently, an impression (a counter mold of the tooth) of a part including the abutment tooth is obtained from the oral cavity of the patient having been subjected to the operation for forming the abutment tooth. A plaster model (a duplicate of the tooth) is produced with the impression, and a dental prosthesis is produced based on the plaster model according to the following manner.

In the case of an acrilic faced cast crown, an acrilic faced cast bridge, a metal crown with porcelain facing and a metal bridge with porcelain facing, a wax model of a core is produced on the plaster model with wax by a lost-wax process and then buried in a refractory investing material. After hardening the refractory investing material, the wax model is burnt out by heating in an electric furnace to obtain a casting mold. A metal is cast in the resulting casting mold to obtain a cast material, which is then dug out from the investing material and machined and ground to produce a metallic core. On the outer surface of the metallic core, a hard resin for dental crown is built-up polymerized, or a ceramic material is built-up and baked, whereby the dental prosthesis is produced. In the case where a full ceramic crown, a duplicate model is produced by using a refractory cast material, and a ceramic material is built-up and baked on the duplicate model. Thereafter, the refractory duplicate model is removed, and then the dental prosthesis is produced through trimming and polishing.

As having been described, the production of a dental prosthesis requires a prolonged period of time and skill because the operation therefor suffers complexity due to demand of significantly high accuracy in micrometer order and differences in shape of oral cavities and shapes of regions, in which the dental prosthesis is to be produced, among respective patients. In other words, the therapeutic period until the dental prosthesis is finally fixed inside the oral cavity of the patient is prolonged, and thus the patient suffers a large cost and a high burden. Furthermore, the operation is an indirect method, and therefore, substantially no case can be obtained where a dental prosthesis having perfect accuracy is produced even though it is produced by a skilled operator.

### SUMMARY OF THE INVENTION

An object of the present invention is to solve the problems associated with the conventional techniques and to provide a prosthesis for a tooth surface having the following features in the case where a dental prosthesis is necessarily produced due to deficiency of a tooth or a part of a tooth is lost. The prosthesis for a tooth surface has such a wear resistance and an aesthetic property that are equivalent to those of the conventional hard resin, and there is no necessity of careful formation of an abutment tooth under consideration of the shape and the structure of the dental prosthesis to be produced later. There is also no necessity of production of a plaster model through obtaining an impression or indirect production of the dental prosthesis outside the oral cavity, and the dental prosthesis can be formed in a short period of time only inside a dental clinic.

As a result of earnest investigations made by the inventors in order to solve the problems, it has been found that, when an abutment tooth is roughly formed, instead of the conventional careful formation of an abutment tooth under consideration of the shape and the structure of the dental prosthesis to be produced later, and a lingual side tooth forming resin material is built-up on the abutment tooth to form a lingual side tooth, upon which, in the case where the therapeutic area is an anterior tooth, a polymer of a mixture containing a polymerizable compound having an unsaturated double bond, a filler and a polymerization initiator, having a shape resembling a labial side surface of the anterior tooth is attached and fixed to a labial side of the lingual side tooth, and in the case where the therapeutic area is a molar tooth, a polymer of a mixture containing a polymerizable compound having an unsaturated double bond, a filler and a polymerization initiator having a shape resembling a buccal side surface and an approximal surface or an occlusal surface of the molar tooth or a buccal side surface or an approximal surface and an occlusal surface of the molar tooth is attached and fixed, there is no necessity of careful formation of an abutment tooth under consideration of the shape and the structure of the dental prosthesis to be produced later, and no necessity of production of a plaster model through obtaining an impression or indirect production of the dental prosthesis outside the oral cavity, and a dental prosthesis can be directly formed in a short period of time only inside a dental clinic. The present invention has been thus accomplished.

Accordingly, the present invention relates to a prosthesis for a tooth surface having a shape resembling a labial side surface of an anterior tooth, a buccal side surface and an approximal surface or an occlusal surface of a molar tooth, or a buccal side surface or an approximal surface and an occlusal surface of a molar tooth, a back surface thereof being attached to a lingual side tooth formed by build-up with a lingual side tooth forming resin material on an abutment tooth, and comprising a polymer of a mixture of a polymerizable compound having an unsaturated double bond, a filler and a polymerization initiator. The prosthesis may be a veneering type having a thickness of 0.1 to 2 mm at a labial side surface of an anterior tooth or a buccal side surface, an approximal surface or an occlusal side surface of a molar tooth, and may be a type having, on a back surface thereof, a protrusion having a hole or a slot, for engaging a post implanted on a tooth root of a remaining tooth.

### BRIEF DESCRIPTION OF THE DRAWINGS

FIG. 1 is a front view showing an example of a prosthesis for a tooth surface for an anterior tooth according to the present invention.

FIG. 2 is a left side view of FIG. 1.

FIG. 3 is a perspective view showing the prosthesis for a tooth surface shown in FIG. 1 viewed from a diagonal back surface side.

FIG. 4 is a perspective view corresponding to FIG. 3 showing another example of a prosthesis for a tooth surface for an anterior tooth according to the present invention.

FIG. 5 is a perspective view corresponding to FIG. 3 showing still another example of a prosthesis for a tooth surface for an anterior tooth according to the present invention.

FIG. 6 is a front view showing an example of a prosthesis for a tooth surface for a canine tooth according to the present invention.

FIG. 7 is a perspective view showing an example of a prosthesis for a tooth surface for a molar tooth according to the present invention, viewed from a diagonal front surface side.

FIG. 8 is a perspective view showing the prosthesis for a tooth surface shown in FIG. 7 viewed from a diagonal back surface side.

FIG. 9 is a perspective view showing another example of a prosthesis for a tooth surface for a molar tooth according to the present invention, viewed from a diagonal front surface side.

FIG. 10 is a side cross sectional view showing a state where the prosthesis for a tooth surface for an anterior tooth shown in FIGS. 1 to 3 is attached to a lingual side tooth formed by build-up with a lingual side tooth forming resin material on an abutment tooth formed with a remaining tooth.

FIG. 11 is a side cross sectional view showing a state where the prosthesis for a tooth surface for an anterior tooth shown in FIG. 4 is attached to a lingual side tooth formed by build-up with a lingual side tooth forming resin material on an abutment tooth formed on a tooth root of a remaining tooth.

FIG. 12 is a side cross sectional view showing a state where the prosthesis for a tooth surface for an anterior tooth shown in FIG. 5 is attached to a lingual side tooth formed by build-up with a lingual side tooth forming resin material on an abutment tooth formed on a tooth root of a remaining tooth.

FIG. 13 is a side cross sectional view showing a state where the prosthesis for a tooth surface for a molar tooth shown in FIGS. 7 and 8 is attached to a lingual side tooth formed by build-up with a lingual side tooth forming resin material on an abutment tooth formed on a tooth root of a remaining tooth.

### DESCRIPTION OF THE PREFERRED EMBODIMENTS

A crown prosthesis according to the present invention will be described in detail with reference to the drawings.

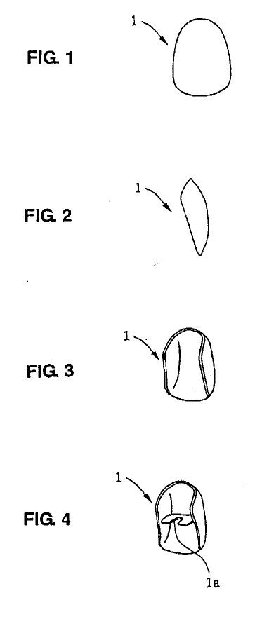

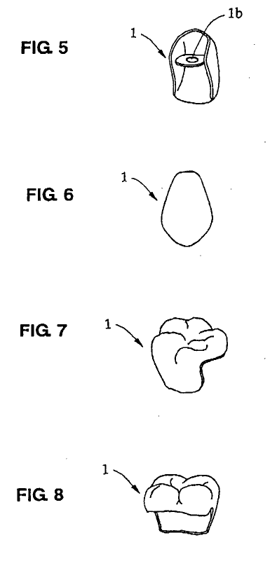

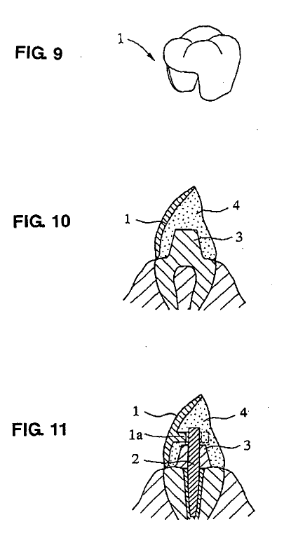

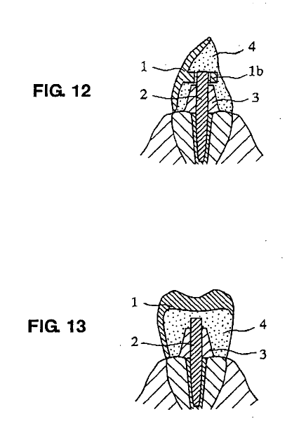

FIG. 1 is a front view showing an example of a prosthesis for a tooth surface for an anterior tooth according to the present invention, FIG. 2 is a left side view of FIG. 1, FIG. 3 is a perspective view showing the prosthesis for a tooth surface shown in FIG. 1 viewed from a diagonal back surface side, FIG. 4 is a perspective view corresponding to FIG. 3 showing another example of a prosthesis for a tooth surface for an anterior tooth according to the present invention, FIG. 5 is a perspective view corresponding to FIG. 3 showing still another example of a prosthesis for a tooth surface for an anterior tooth according to the present invention, FIG. 6 is a front view showing an example of a prosthesis for a tooth surface for a canine tooth according to the present invention, FIG. 7 is a perspective view showing an example of a prosthesis for a tooth surface for a molar tooth according to the present invention, viewed from a diagonal front surface side, FIG. 8 is a perspective view showing the prosthesis for a tooth surface shown in FIG. 7 viewed from a diagonal back surface side, FIG. 9 is a perspective view showing another example of a prosthesis for a tooth surface for a molar tooth according to the present invention, viewed from a diagonal front surface side, FIG. 10 is a side cross sectional view showing a state where the prosthesis for a tooth surface for an anterior tooth shown in FIGS. 1 to 3 is attached to a lingual side tooth formed by build-up with a lingual side tooth forming resin material on an abutment tooth formed with a remaining tooth, FIG. 11 is a side cross sectional view showing a state where the prosthesis for a tooth surface for an anterior tooth shown in FIG. 4 is attached to a lingual side tooth formed by build-up with a lingual side tooth forming resin material on an abutment tooth formed on a tooth root of a remaining tooth, FIG. 12 is a side cross sectional view showing a state where the prosthesis for a tooth surface for an anterior tooth shown in FIG. 5 is attached to a lingual side tooth formed by build-up with a lingual side tooth forming resin material on an abutment tooth formed on a tooth root of a remaining tooth, and FIG. 13 is a side cross sectional view showing a state where the prosthesis for a tooth surface for a molar tooth shown in FIGS. 7 and 8 is attached to a lingual side tooth formed by build-up with a lingual side tooth forming resin material on an abutment tooth formed on a tooth root of a remaining tooth.

In the figures, numeral 1 denotes a prosthesis for a tooth surface according to the present invention, which contains a polymer of a mixture of a polymerizable compound having an unsaturated double bond, a filler and a polymerization initiator. The composition is the same as the conventional dental resin materials, which are referred to as hard resins, and therefore, the prosthesis for a tooth surface has the characteristics owned by the conventional hard resin tooth, i.e., excellent wear resistance and excellent aesthetic property.

As the polymerizable compound having an unsaturated double bond used in the prosthesis for a tooth surface 1 according to the present invention, a polymerizable compound having an unsaturated double bond used for dental prostheses, such as a conventional hard resin, can be used, and in general, a monomer or an oligomer of methacrylate or acrylate having an unsaturated double bond is used. Specific examples of the polymerizable compound having an unsaturated double bond include methyl methacrylate, ethyl methacrylate, isopropyl methacrylate, 2-hydroxyethyl methacrylate, 3-hydroxypropyl methacrylate, 2-hydroxy-1,3-dimethacryloxypropane, n-butyl methacrylate, isobutyl methacrylate, butoxyethyl methacrylate, hydroxypropyl methacrylate, tetrahydrofurfuryl methacrylate, glycidyl methacrylate, 2-methoxyethyl methacrylate, 2-ethylhexyl methacrylate, benzyl methacrylate, ethylene glycol dimethacrylate, diethylene glycol dimethacrylate, triethylene glycol dimethacrylate, triethylene glycol trimethacrylate, butylene glycol dimethacrylate, neopentyl glycol dimethacrylate, 1,3-butanediol dimethacrylate, 1,4-butanediol dimethacrylate, 1,6-hexanediol dimethacrylate, trimethylolpropane trimethacrylate, trimethylolethane trimethacrylate, trimethylolmethane trimethacrylate, pentaerythritol trimethacrylate, pentaerythritol tetramethacrylate, polyoxytetraethylene glycol dimethacrylate, 2,2-bis(methacryloxyphenyl)propane, 2,2-bis(4-(2-hy droxy-3-methacryloxypropoxy)phenyl)propane, 2,2-bis (4-methacryloxydiethoxyphenyl)propane, 2,2-bis(4-methacryloxypolyethoxyphenyl)propane and an acrylate thereof, and a methacrylate having a urethane bond in the molecule, such as di-2-metahcryloxyethyl-2, 2, 4-trimethylhexamethylene dicarbamate, 1,3,5-tris(1,3-bis(methacyrloyloxy)-2-propoxycarbo nylaminohexane)-1,3,5-(1H, 3H, 5H)triazin-2,4,6-trio ne, a urethane oligomer synthesized of 2,2′-di(4-hydroxycyclohexyl)propane, 2-oxepanone, hexamethylene diisocyanate and 2-hydroxyethyl methacrylate, and a urethane oligomer synthesized of 1,3-butanediol, hexamethylene diisocyanate and 2-hydroxyethyl methacrylate.

The mixing amount of the polymerizable compound having an unsaturated double bond in the prosthesis for a tooth surface 1 according to the present invention is preferably 20 to 70% by weight based on the total weight while it varies depending on the filler used in combination. In the case where the mixing amount of the polymerizable compound having an unsaturated double bond is less than 20% by weight, there is such a tendency that the flexural strength is lowered, and in the case where it exceeds 70% by weight, there is such a tendency that the wear resistance is deteriorated.

The filler is mixed for imparting mechanical strength, such as wear resistance and breakage resistance, to the prosthesis for a tooth surface 1 according to the present invention. Fillers used for the general hard resin can be used as the filler, and examples thereof include an inorganic filler containing powder of glass, such as silicon dioxide, barium glass, alumina glass, potassium glass and fluoroaluminosilicate glass, synthetic zeolite, calcium phosphate, feldspar, fumed silica, aluminum silicate, calcium silicate, magnesium carbonate and quartz. The inorganic filler may be subjected to a surface treatment with γ-methacryloxypropyltrimethoxysilane, vinyltrichlorosilane, vinyltriethoxysilane, vinyltrimethoxysilane, vinyltriacetoxysilane, vinyltri(methoxyethoxy)silane or the like. A so-called organic-inorganic composite filler, which is produced by the inorganic filler being mixed with a polymerizable monomer or oligomer, hardened and then pulverized, and polymer powder can also be used.

The mixing amount of the filler is preferably from 25 to 75% by weight based on the total weight. In the case where the mixing amount of the filler is less than 25% by weight, there is such a tendency that the wear resistance of the prosthesis for a tooth surface 1 according to the present invention is lowered, and in the case where it exceeds 75% by weight, there is such a tendency that the flexural strength is deteriorated.

As the polymerization initiator used in the prosthesis for a tooth surface 1 according to the present invention, those of heat polymerization type are mainly used, and for example, an organic peroxide and an azo compound are used. The organic peroxide is preferably a diacylperoxide having aromatic series and a peroxyester that can be regarded as an ester of perbenzoic acid, and specific examples thereof include benzoyl peroxide, 2,4-dichlorobenzoyl peroxide, m-tolyl peroxide, t-butyl peroxybenzoate, di-t-butyl peroxyisophthalate, 2,5-dimethyl-2,5-di(benzoylperoxy) hexane and 2,5-dimethyl-2,5-di((o-benzoyl)benzoylperoxy) hexane, which can be effectively used. Examples of the azo compound include azobisisobutyronitrile, and in addition, an organic metal compound, such as tributylboron, can also be used.

The lingual side tooth forming resin material used upon using the prosthesis for a tooth surface 1 according to the present invention having the foregoing composition is a dental resin material that is generally referred to as a composite resin, and is preferably a composite resin having a low viscosity in comparison to a composite resin used for filling a tooth. The lingual side tooth forming resin material may be the same dental resin material such as a dental composite resin or a dental composite resin for core build-up.

The prosthesis for a tooth surface 1 has a shape resembling a labial side surface of an anterior tooth a shape resembling a buccal side surface and an approximal surface or an occlusal surface of a molar tooth, or a shape resembling a buccal surface or an approximal surface and an occlusal surface of a molar tooth, and is attached, on a back surface thereof, to a lingual side tooth formed by build-up with a lingual side tooth forming resin material on an abutment tooth. Examples of the shape thereof include veneering types having a thickness of type 0.1 to 2 mm as shown in FIGS. 1 to 3 and 7 to 9, a form having on a back surface thereof a protrusion 1a having a slot, with which a post 2 implanted on a tooth root of a remaining tooth is engaged, as shown in FIG. 4, and a type having on a back surface thereof a protrusion 1b having a hole, in which a post 2 implanted on a tooth root of a remaining tooth is penetrated. The veneering type is applied particularly to a case where aesthetic property is important. In the case of a thickness of less than 0.1 mm, the strength of the prosthesis is insufficient, and in the case where it exceeds 2 mm, a color tone similar to a natural tooth is difficult to be obtained, and adjustment of color becomes difficult when utilizing the color tone of the lingual side tooth formed by build-up with the lingual side tooth forming resin 4 on the abutment tooth 3 at the back side thereof. The type having, on a back surface thereof, the protrusion 1b having a hole or the protrusion 1a having a slot, in which a post 2 implanted on a tooth root of a remaining tooth is engaged with or penetrated into, is applied to a case where the operationaility and the strength are important when producing a dental prosthesis, and in this case, such a color tone is selected that is accommodated with a color tone of the lingual side tooth formed by build-up the lingual side tooth forming resin 4 on the abutment tooth 3, to which the back surface of the prosthesis for a tooth surface 1 according to the present invention is attached.

In the prosthesis for a tooth surface 1 according to the present invention, in order to obtain an effect in the using method described later, it is preferred that the refractive index of the compound having an unsaturated double bond and the filler is adjusted, or the transparency is adjusted by mixing mainly titanium oxide as a turbidizing agent, whereby the prosthesis for a tooth surface 1 is adjusted to be transparent or translucent, i.e., such color tone and transparency that are generally referred to as enamel in the field of dentistry, because the color tone of the lingual side tooth formed by build-up the lingual side tooth forming resin 4 on the abutment tooth 3 at the backside can be reflected on the prosthesis, and the color of the lingual side tooth forming resin 4 can be adjusted as needed when build-up it on the abutment tooth 3, whereby the color of the repaired tooth can be easily and accurately accommodated with the adjacent natural tooth. It is also possible that the prosthesis for a tooth surface 1 according to the present invention contains a coloring agent that is contained in the conventional hard resin.

In the method for using the prosthesis for a tooth surface 1 according to the present invention, there is no necessity of careful formation of an abutment tooth under consideration of the shape and the structure of the dental prosthesis to be produced later, and there is no necessity of indirect operations, such as formation of an impression, production of a plaster model, and production of a dental prosthesis outside an oral cavity, but a dental prosthesis for an anterior tooth, a canine tooth or a molar tooth is formed only by a direct operation carried out inside an oral cavity, i.e., an abutment tooth 3 is roughly formed, and a prosthesis for a tooth surface 1 is attached to a lingual side tooth formed by build-up a lingual side tooth forming resin 4 on the abutment tooth 3.

Specifically, in the case where the prosthesis is fixed to a tooth, and only a tooth root of the tooth remains, a dental prosthesis is formed in the following manner. A root canal having been subjected to root canal preparation is filled with a dental adhesive or a dental resin material, such as a dental composite resin for core build-up, and a post 2 is implanted therein. In the case where the root canal is filled with the dental resin material, the dental resin material is polymerized depending on necessity, and a part corresponding to the conventional abutment tooth is built-up by using a dental composite resin for core build-up. After forming the abutment tooth 3 through polymerization depending on necessity, a lingual side tooth forming resin 4 is built-up on the abutment tooth 3 to form a lingual side tooth, the prosthesis for a tooth surface 1 according to the present invention is attached to the labial side surface or an approximal surface of the lingual side tooth. Thereafter, the shape of the lingual side surface is finished into the shape of a natural tooth (as well as the shape on the buccal side surface, in the case where the shape of the prosthesis for a tooth surface 1 according to the present invention resembles the approximal surface as shown in FIG. 9, and the shape on the occlusal surface, in the case where the shape of the prosthesis for a tooth surface 1 according to the present invention does not resemble the occlusal surface, while not shown in the figures). At this time, in the case where the prosthesis for a tooth surface 1 according to the present invention is a veneering type having a thickness of 0.1 to 2 mm as shown in FIGS. 7, 8 and 9, such a dental prosthesis is obtained that has the similar conformation to that shown in FIG. 13. In the case where the prosthesis is type that a protrusion 1a with a slot is formed on the back surface thereof, in which a post 2 implanted on a tooth root of a remaining tooth is engaged as shown in FIG. 4, such a dental prosthesis is obtained that has the similar conformation to that shown in FIG. 11. In the case where the prosthesis is a type that a protrusion 1b with a hole is formed on the back surface thereof, in which a post 2 implanted on a tooth root of a remaining tooth is penetrated as shown in FIG. 5, such a dental prosthesis is obtained that has the similar conformation to that shown in FIG. 12.

A thin one layer of an adjacent tooth at the part that is in contact with the repaired tooth may be cut off, followed by subjecting the cut surface to a tooth surface treatment with an acid such as citric acid or phosphoric acid, whereby the prosthesis for a tooth surface 1 according to the present invention to be the repaired tooth can be surely fixed.

In the case where the prosthesis is fixed to a remaining tooth, and the remaining tooth has a substantially complete shape, a dental prosthesis is formed in the following manner. The remaining tooth is machined into an abutment tooth 3 having a rough shape with a turbine, and the abutment tooth 3 is subjected to a tooth surface treatment with an acid or a primer treatment. A lingual side tooth forming resin 4 is then built-up thereon to form a lingual side tooth. The prosthesis for a tooth surface 1 according to the present invention is attached to the labial side surface or the approximal surface of the lingual side tooth, and the shape of the lingual side surface is finished into the shape of a natural tooth (as well as the shape on the buccal side surface, in the case where the shape of the prosthesis for a tooth surface 1 according to the present invention resembles the approximal surface as shown in FIG. 9, and the shape on the occlusal surface, in the case where the shape of the prosthesis for a tooth surface 1 according to the present invention does not resemble the occlusal surface, while not shown in the figures).

At this time, the dental prosthesis shown in FIG. 10 is completed in the following manner. Contact surfaces of the abutment tooth 3 thus formed and the adjacent tooth are subjected to a surface treatment with an acid, such as citric acid and a phosphoric acid, and such an operation is repeated in that a lingual side tooth forming resin material 4 is built-up on the treated surface and polymerized, followed by repaired, so as to arrange a rough shape of the lingual side tooth. The prosthesis for a tooth surface 1 according to the present invention is attached to the labial side surface or the approximal surface of the shape by using the lingual side tooth forming resin 4 or a dental adhesive. Thereafter, the shape of the lingual side surface is finished into the shape of a natural tooth (as well as the shape on the buccal side surface, in the case where the shape of the prosthesis for a tooth surface 1 according to the present invention resembles the approximal surface as shown in FIG. 9, and the shape on the occlusal surface, in the case where the shape of the prosthesis for a tooth surface 1 according to the present invention does not resembles the occlusal surface, while not shown in the figures).

### EXAMPLES

The present invention will be described in more detail with reference to the examples below.

### Example 1

10.0% by weight of triethylene glycol dimethacrylate and 19.0% by weight of di-2-methacryloxyethyl-2,2,4-trimethylhexamethylene dicarbamate as the compounds having an unsaturated double bond, 1% by weight of azobisisobutyronitrile as the polymerization initiator, and 21.2% by weight of an organic-inorganic composite filler, 45.7% by weight of glass powder having an average particle diameter of 5 μm and 3.1% by weight of colloidal silica having an average particle diameter of 0.04 μm as the fillers were mixed, and a pigment in an amount within a range of 0.3 part by weight or less was added and mixed with 100 part by weight of the mixture to adjust the transparency and the color, so as to obtain a mixture in a uniform paste form. The mixture was pressed at 90° C. for 60 minutes in a metallic mold for forming an artificial tooth, so as to produce a prosthesis for a tooth surface of a enamel color having a thickness of 0.2 to 0.7 mm and a front shape resembling the shape of a labial side surface of an anterior tooth.

The organic-inorganic composite filler used in Example 1 and Example 2 described later was a colloidal silica organic-inorganic composite filler having an average particle diameter of 19 μm produced in the following manner. Azobisisobutyronitrile as a polymerization catalyst in an amount of 1% by weight was added to a mixture obtained by mixing di-2-methacryloxyethyl-2,2,4-trimethylhexamethylene dicarbamate and triethylene glycol dimethacrylate at a weight ratio of 3/7 to form a mixed solution, and 70% by weight of the mixed solution and 30% by weight of colloidal silica having an average particle diameter of 0.04 μm were mixed and hardened by heating, followed by pulverization.

A restorating method will be described for the case where the prosthesis for a tooth surface for an anterior tooth of Example 1 is fixed to a remaining tooth, and only a tooth root of the remaining tooth remains.

A tooth to be remedied was subjected to root canal preparation according to an ordinary method to form a post hole. The post hole was treated with a dental primer (Unifil Core Self-etching Bond, a trade name, produced by GC Corp.) and filled with a dental composite resin for core build-up (Unifil Core Composite Paste, a trade name, produced by GC Corp.), and a post (D. T. LIGHT-POST, a trade name, produced by RTD Corp.) was inserted therein. A gap between the tooth and the post was filled with the dental composite resin for core build-up, and then the dental composite resin for core build-up was polymerized to implant the post. Subsequently, a rough abutment tooth was formed around the post protruding from the root canal as a core by using the dental composite resin for core build-up, and the dental composite resin material was polymerized. Thereafter, a dental composite resin (various colors of Unifil Flow, a trade name, produced by GC Corp.) was prepared as the lingual side tooth forming resin material having the substantially same composition as the dental composite resin for core build-up and a color tone accommodated with a natural tooth was prepared, and the lingual side tooth forming resin was built-up on the abutment under conformation in color tone with the adjacent tooth, so as to form a lingual side tooth. Before polymerizing the lingual side tooth forming resin, the prosthesis for a tooth surface for an anterior tooth was set on the labial side surface of the lingual side tooth, and then fixed by polymerizing the lingual side tooth forming resin material. Thereafter, the shape of the lingual side surface of the lingual side tooth was adjusted depending on necessity by using the lingual side tooth forming resin, followed by polymerizing, to form a dental prosthesis for an anterior tooth.

### Example 2

7.1% by weight of trimethylolpropane trimethacrylate and 21.8% by weight of di-2-methacryloxyethyl-2,2,4-trimethylhexamethylene dicarbamate as the compounds having an unsaturated double bond, 1% by weight of azobisisobutyronitrile as the polymerization initiator, and 16.2% by weight of an organic-inorganic composite filler, 45.7% by weight of glass powder having an average particle diameter of 5 μm and 8.2% by weight of colloidal silica having an average particle diameter of 0.04 μm as the fillers were mixed, and a pigment in an amount within a range of 0.6 part by weight or less was added and mixed with 100 part by weight of the mixture to adjust the transparency and the color, so as to obtain a mixture in a uniform paste form. The mixture was pressed at 95° C. for 60 minutes in a metallic mold for forming an artificial tooth to produce a prosthesis for a tooth surface of a enamel color for an anterior tooth having a thickness of 0.3 to 0.9 mm and a front shape resembling the form of a labial side surface of an anterior tooth as shown in FIGS. 1 to 3.

A restorating method will be described for the case where the prosthesis for a tooth surface for an anterior tooth of Example 2 is fixed to a remaining tooth, and the remaining tooth has a substantially complete shape.

A remaining tooth to be remedied was machined into a rough shape with a turbine, and a dental composite resin for core build-up (Unifil Core Composit Paste, a trade name, produced by GC Corp.) as a lingual side tooth forming resin material having the substantially same composition as a dental composite resin material generally used and a color tone accommodated with a natural tooth was prepared. After subjecting a contact surface of an adjacent tooth to a surface treatment with an acid, such as citric acid and phosphoric acid, the lingual side tooth forming resin material was built-up on the abutment tooth to form a lingual side tooth. The prosthesis for a tooth surface for an anterior tooth was set on the labial side of the lingual side tooth, and then fixed by polymerizing the lingual side tooth forming resin material. Thereafter, the shape of the lingual side surface of the lingual side tooth was adjusted depending on necessity by using the lingual side tooth forming resin, followed by polymerizing, to form a dental prosthesis for an anterior tooth.

As described in detail in the foregoing, the prosthesis for a tooth surface according to the present invention is for producing a dental prosthesis in such a manner that an abutment tooth is roughly formed, and a lingual side tooth forming resin material is built-up on the abutment tooth to form a lingual side tooth, on which the dental prosthesis is fixed on the labial side surface or an approximal surface of the lingual side tooth. Therefore, there is no necessity of careful formation of an abutment tooth under consideration of the shape and the structure of the dental prosthesis to be produced later, no necessity of formation of an impression or production of a plaster model, or no necessity of production of a dental prosthesis based on complicated operations in a dental laboratry, and dental remedy with accurate color tone can be easily carried out in a short period of time with a one-time treatment inside a dental clinic. Consequently, the crown prosthesis exerts significant value through contribution to dental remedy.

What is claimed is:

1. A prosthesis for a tooth surface having a shape resembling a labial side surface of an anterior tooth, a buccal side surface and an approximal surface or an occlusal surface of a molar tooth, or a buccal side surface or an approximal surface and an occlusal surface of a molar tooth, a back surface thereof being attached to a lingual side tooth formed by build-up with a lingual side tooth forming resin material on an abutment tooth, and comprising a polymer of a mixture of a polymerizable compound having an unsaturated double bond, a filler and a polymerization initiator.

2. A prosthesis for a tooth surface as claimed in claim 1, wherein the prosthesis has a thickness of from 0.1 to 2 mm at a labial side surface of an anterior tooth, or a buccal side surface, an approximal surface or an occlusal surface of a molar tooth.

3. A prosthesis for a tooth surface as claimed in claim 1 or 2, wherein the prosthesis has, on a back surface thereof, a protrusion having a hole or a slot a hole, which a post implanted on a tooth root of a remaining tooth is penetrated into or engaged with.
